(19) United States
(12) Patent Application Publication
(10) Pub. No.: US 2007/0114734 A1
(43) Pub. Date: May 24, 2007

(54) Telescopic stabilizer for trailers and related vehicles having a two axes stabilizing characteristic

(76) Inventor: Rene Jacques, Roxton Pond (CA)

Correspondence Address: INVENTARIUM, Suite 1607, 4050 Rosemont blvd, Montreal, QC, H1X 1M4, CA

(21) Appl. No.: 11/644,761

(22) Filed: Dec. 22, 2006

Related U.S. Application Data
(63) Continuation-in-part of application No. 10/991,646, filed on Nov. 18, 2004.

(51) Int. Cl. B60G 17/00

(52) U.S. Cl. 280/6.153

(57) ABSTRACT

A telescopic stabilizer for travel trailer, fifth wheel, or motorhome which can extend to the required length no matter the distance between each jacks and is set up diagonally so that it creates a cross beam of sort which reinforces and stabilizes two otherwise separate jacks. Moreover, when a second telescopic stabilizer is added to a third jack or riser and set perpendicular to the first two, this creates a second axis to provide ultimate stability across the width and the length of the travel trailer, fifth wheel, or motorhome. More stabilizers can be added to cover all corners of the travel trailer, fifth wheel, or motorhome if required.

This application is a continuation in part of application Ser. No. 10/991,646 filed Nov. 18, 2004

### FIELD OF THE INVENTION

The invention relates generally to leveling and stabilizing equipment but more particularly to a telescopic stabilizer that stabilzes along two axes and designed for fifth wheels, travel trailers, or motorhomes.

### BACKGROUND OF THE INVENTION

Prior Art Capability and Motivations, as Helping to Show Patentability Here

Even in hindsight consideration of the present invention to determine its inventive and novel nature, it is not only conceded but emphasized that the prior art had many details usable in this invention, but only if the prior art had had the guidance of the present invention, details of both capability and motivation.

That is, it is emphasized that the prior art had/or knew several particulars which individually and accumulatively show the non-obviousness of this combination invention. E.g.,
a) the ability to use already available components on the fifth wheels, travel trailers, or motorhomes.
b) The nature of an invention as being a “novel combination”, in spite of existence of details separately, is especially significant here where the novelty is of the plurality of concepts, i.e., the use of a stabilizing telescopic rod with existing risers and jacks found on fifth wheels, travel trailers, or motorhomes;
c) The addition of providing stabilizing features along two perpendicular axes;
d) The matter of particular cost-factors, in a detailed form which would surely convey the realization of the low costs involved in manufactring such a device;
e) The ease of tooling for the present invention has surely given manufacturers ample incentive to have made modifications for commercial competitiveness in a competitive industry, if the concepts had been obvious;
f) The prior art has always had sufficient skill to make many types of leveling and stabilizing devices for the RV market, more than ample skill to have achieved the present invention, but only if the concepts and their combinations had been conceived;
g) Substantially all of the operational characteristics and advantages of details of the present invention, when considered separately from one another and when considered separately from the present invention's details and accomplishment of the details, are within the skill of persons of various arts, but only when considered away from the integrated and novel combination of concepts which by their cooperative combination achieve this advantageous invention;
h) The details of the present invention, when considered solely from the standpoint of construction, are exceedingly simple, basically a pair of perpendicularly positioned telescopic rods that can be locked into position and which are connected to the structure needing stabilization and jacks or risers also attached to the structure and the matter of simplicity of construction has long been recognized as indicative of inventive creativity;
i) Similarly, and a long-recognized indication of inventiveness of a novel combination, is the realistic principle that a person of ordinary skill in the art, as illustrated with respect to the claimed combination as differing in the stated respects from the prior art both as to construction and concept, is presumed to be one who thinks along the line of conventional wisdom in the art and is not one who undertakes to innovate; and
j) The predictable benefits from a novel product and installation method having the features of this invention would seem sufficiently high that others would have been working on this type of product, but only if the concepts which it presents had been conceived.

Accordingly, although the prior art has had capability and motivation, amply sufficient to presumably give incentive to the development a product and installation method according to the present invention, the fact remains that this invention awaited the creativity and inventive discovery of the present Inventor. In spite of ample motivation, the prior art did not suggest this invention.

Prior Art as Particular Instances of Failure to Provide this Novel Product and Installation Method

In view of the general advantages of the present invention as an improved embodiment of the prior art, it may be difficult to realize that the prior art has not conceived of the combination purpose and achievement of the present invention, even though the need for a reliable and easy to use and install stabilizing device which truly stabilizes along two axes is a known requested commodity for people nowadays who want to occupy a stable motorhome or trailer that does not shake as one moves about within the structure or that remains stable when strong winds prevail. Surely the need for such a feature has been known for decades and the technology to achieve such results has been known for years and that the various combination provided in this invention would have been desired and attempted long ago, but only if its factors and combination-nature had been obvious. Moreover, the camping industry is a huge industry and the problem of trailer stability has been felt for a long time and that long felt need has not yet been fully resolved, that is not until this instant invention which is currently selling very well at specialized trade shows.

Other considerations, as herein mentioned, when realistically evaluated show the inventive nature of the present invention, a change in concept which the prior patent and other prior art did not achieve.

Summary of the Prior Art's Lack of Suggestions of the Concepts of the Invention's Combination

And the existence of such prior art knowledge and related ideas embodying such various features is not only conceded, it is emphasized; for as to the novelty here of the combination, of the invention as considered as a whole, a contrast to the prior art helps also to remind of needed improvement, and the advantages and the inventive significance of the present concepts. Thus, as shown herein as a contrast to all the prior art, the inventive significance of the present concepts as a combination is emphasized, and the nature of the concepts and their results can perhaps be easier seen as an invention.

Although varieties of prior art are conceded, and ample motivation is shown, and full capability in the prior art is conceded, no prior art shows or suggests details of the overall combination of the present invention, as is the proper and accepted way of considering the inventiveness nature of the concepts.

That is, although the prior art may show an approach to the overall invention, it is determinatively significant that none of the prior art shows the novel and advantageous concepts in combination, which provides the merits of this invention, even though certain details are shown separately from this accomplishment as a combination.

And the prior art's lack of an invention of a reliable and easy to use and install stabilizing device which truly stabilizes along two axes and other advantages of the present invention, which are goals only approached by the prior art, must be recognized as being a long-felt need now fulfilled. For example, U.S. Pat. No. 3,454,251 by Dye shows a stabilizer along one axis only and with both stabilizing cross rods being attached onto the riser either directly or indirectly by way of brackets attached to the risers. This does not reliably connect the stabilizers to the structure itself so that the structure (the trailer, motorhomne, etc) is not truly stabilized. Moreover, the risers are not like jacks and as such can only secure a rest position, whether or not it is a leveled rest position. The use of jacks would be required as an external component in order to lift the trailer for leveling purposes. Furthermore, the mere repetition of Dye along two perpendicular axes would not be feasible because of the way the legs fold which would make the arrangement conflicting. Moreover, a simple repetition of Dye along two axes still does not meet this instant invention since the two axes, following Dye's teachings would be distinct and separate whereas in this invention, both axes share a common element, namely a jack or a riser so the axes are not separate elements and it is that fact that insures the strength and stability of this present invention. Lifting a trailer and leveling it is simple enough but once lifted, are the jacks stable enough to carry the weight and the weight shifts caused by wind; or people moving inside the travel trailer, fifth wheel, or motorhome; or shifting tires and suspension; or the vibrations surrounding a trailer coming from traffic and other such sources of vibrations? Another prior art, U.S. Pat. No. 6,505,447 by Oliver does not provide for a symmetrical two axes stabilization since the spread of one axis is limited to that of a platform which does not provide wide enough of a span to be efficient for the purpose of stabilizing mobile structures. And again, Oliver does not integrate a jack as part of his invention and that, simply because the invention of Oliver is from an unrelated field and although it may be adequate for static building structures such as commercial office buildings and the like, the teachings of Oliver cannot be reliably used in the context of use of this instant invention.

Other prior art of less relevance include:

U.S. Pat. No. 6,168,227 which consists in a pair of elongated frame members mounted in parallel to the bottom of a camper. A pair of leg assemblies are pivotally supported intermediate the elongated frame members. Each leg assembly includes a crossbar, a pair of outer sleeves attached to the crossbar, and a pair of telescoping members with each telescoping member being positioned at least in part within a respective one of the outer sleeves. Each telescoping member has a plurality of holes, a selected one of which is engaged by a pin passing through the respective outer sleeve to fix the length of each leg. Each leg assembly is fixed in the extended position by a pair of detachable braces. The leg assemblies are folded to lie flat against the bottom of the camper to permit the camper to be mounted on the bed of a truck.

Others provide folding legs held onto a subframe structure, such as in U.S. Pat. No. 3,933,372 and which consists in a pair of extensible leveling and stabilizing legs connected pivotally to the underside of a trailer, the legs can be raised from their ground engaging position extending downward to the ground in an outward direction transverse to the longitudinal axis of the trailer, to a retracted position extending parallel to the underside of the trailer. Force means are provided which tend to move the legs toward each other and thus continuously maintain stabilizing and leveling contact of the ground engaging portion of the legs with the ground. The force means can also be used to maintain the legs in a raised and retracted position.

Others are more concerned with lateral motion stabilization such as against strong winds such as U.S. Pat. No. 4,268,066 and which consists in an elongated strut having first and second large and small diameter relatively telescoped opposite end portions. The free end of the large diameter end portion includes a mount for mounting a corresponding vehicle side with the strut downwardly and outwardly inclined from the vehicle side. The free end of the small diameter end portion includes a relatively extendable spring biased foot portion for engagement with the ground and a generally horizontal brace is provided including a first end for anchoring relative to the corresponding vehicle side and a second end including clamp structure removably clampingly engaged with the strut small diameter end portion immediately adjacent and abutting the corresponding strut large diameter end portion to limit telescoping of the small diameter strut end portion into the strut large diameter end portion.

Still others offer a stand for the part normally held on a hitch as for fifth wheel trailers such as U.S. Pat. No. 5,141,197 which consists in a mountable support for a modular unit, such as a camper body, including telescoping support pillars with pivotal pads as well as telescoping arms for longitudinal support against inadvertent forward or rear section rotation from the support position, which is affixed to the body for storage at a reference position and having pivotal forward and rear sections for rotation to a support position for storage of the body after its removal from a transport vehicle bed.

Accordingly, the various concepts and components are conceded and emphasized to have been widely known in the prior art as to various installations; nevertheless, the prior art not having had the particular combination of concepts and details as here presented and shown in novel combination different from the prior art and its suggestions, even only a fair amount of realistic humility, to avoid consideration of this invention improperly by hindsight, requires the concepts and achievements here to be realistically viewed as a novel combination, inventive in nature. And especially is this a realistic consideration when viewed from the position of a person of ordinary skill in this art at the time of this invention, and without trying to reconstruct this invention from the prior art without use of hindsight toward particulars not suggested by the prior art.

Features and Advantages of the Invention

In view of the foregoing disadvantages inherent in the known devices now present in the prior art, the present invention, which will be described subsequently in greater detail, is to provide objects and advantages which are:

To provide for a telescopic stabilizer that is safe and secure.

To provide for a telescopic stabilizer that is easy to mount and dismount. Since it is permanently fixed underneath the travel trailer, fifth wheel, or motorhome itself.

To provide for a telescopic stabilizer that is totally unobtrusive when not in use.

To provide for a telescopic stabilizer that does not use storage space usually needed for blocks, jacks and related paraphernalia as is often the case when using traditional stabilizing methods.

To provide for a telescopic stabilizer that operates on two axes to provide true stabilization along two axes.

To provide for a telescopic stabilizer that combines with existing risers and jacks as found on travel trailer, fifth wheel, or motorhome and which adds the feature of stability.

To provide for a telescopic stabilizer with very precise adjustement of level by using the existing jacks and risers.

To provide for a telescopic stabilizer that makes use of parts that are easily available such as jacks and risers, which can easily be replaced if damaged or easily obtainable in cases where there components are not already part of the structure needing stabilizing.

### SUMMARY OF THE INVENTION

To attain these ends, the present invention generally comprises at least one set of two perpendicularly positioned telescopic stabilizers which extend to the required length according to the type of vehicle it is to stabilize in order to create long cross beams that are effective as stabilizers. The telescopic stabilizers are located perpendicularly from each others and share one common jack or riser at one of their end and have their other ends attached to the structure to be stabilized. More than one such pair of telescopic stabilizers can be used on a single structure. For simplification, for the rest of the document the term trailer or structure will be used to described all types of travel trailers, fifth wheels, motorhomes, etc. . .

Once the components are installed underneath the trailer, they remain there and need be deployed only when needed, and retracted when no longer needed.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Side elevation of a fifth wheel, in ghost lines, showing two telescopic stabilizers and two jacks.

FIG. 2ab Side and top elevation of a complete telescopic stabilizer, respectively.

FIG. 2cd Side and top elevation of the first part of a variation of a telescopic stabilizer, respectively.

FIG. 2ef Side and isometric view of an attachment bracket, respectively.

FIG. 3 Rear elevation of a fifth wheel, in ghost lines, showing one telescopic stabilizer set at a right angle from the one seen in FIG. 1.

FIG. 4 Font elevation of a fifth wheel, in ghost lines, showing one telescopic stabilizer.

FIGS. 5ab Side elevation details of mechanical connections to top (a) and bottom (b) of jacks or risers.

FIG. 6 is a perspective view showing that 3 telescopic stabilizers set along two perpendicular axes from the front axis can be used to provide adequate stability.

### DETAILED DESCRIPTION

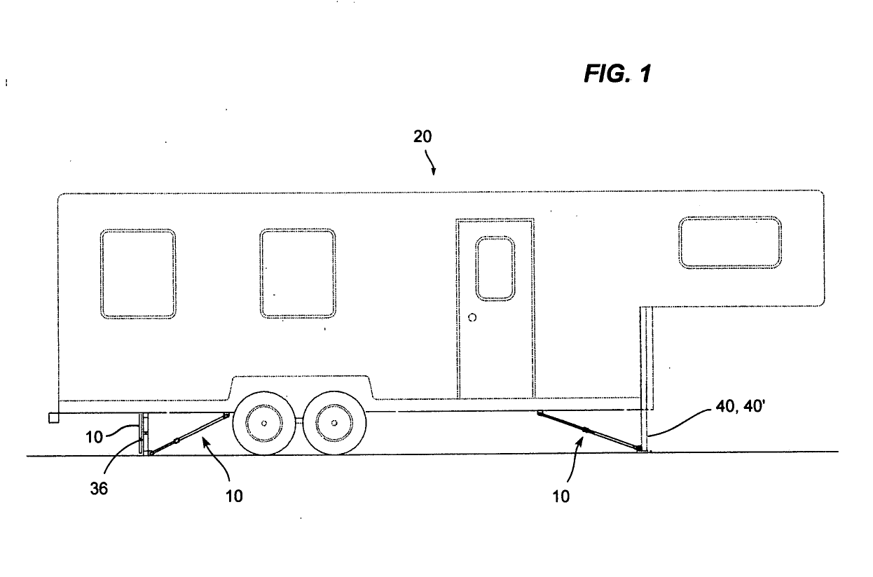

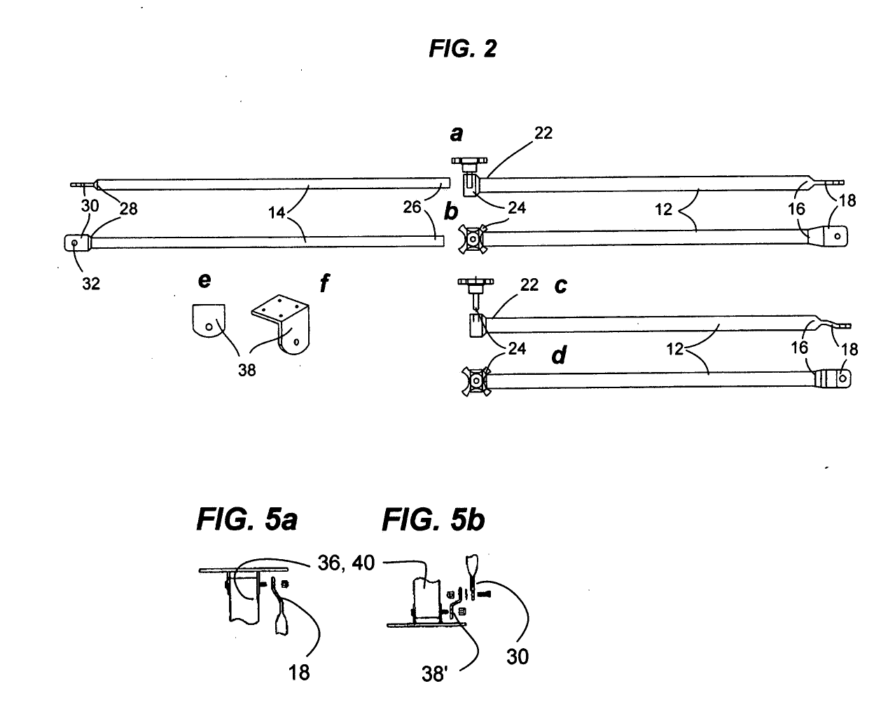

FIGS. 1 and 2 A telescopic stabilizer (10) for use on trailers (20) has two sections: a hollow section (12) which receives a telescoping section (14). A hollow section first end (16) has a connector (18) extending therefrom and from which is connected a structural bracket (38). This structural bracket (38) is so named because it is mechanically connected to the structure of the trailer (20). The same type of structural bracket (38) can also be connected to a jack (36) or a riser (40). That jack (36) or a riser (40) is itself connected with another telescopic stabilizer (10′) which is set perpendicularly to the first telescopic stabilizer (10) in order to form a second axis.

An alternate structural bracket (38′) can be seen in FIG. 5b and which is designed more specifically to risers (40) which are more commonly found on fifth wheel trailers. A hollow section second end (22) has an adjustment means (24) to selectively release or block the telescoping section (14) so that the overall length of the telescopic stabilizer (10) can be locked at a given point to secure the trailer (20). As an example, a threaded knob is shown here as the adjustment means (24). The telescoping section (14) has a telescoping section first end (26) which is always encased within the hollow section (12) and a telescoping section second end (28) which has a tabbed connector (30) extending therefrom. This tabbed connector (30) has a hole (32) so that a mechanical fastener (34) can pass therethrough.

FIGS. 2cd show a variation of the hollow section (12) wherein the connector (18) is bent so as to more readily adapt to the type of connection required whether on the jack (36), riser (40) or structural bracket (38).

As FIG. 4 shows, there are different kinds of jacks (36) or risers (40) and using the <<L>> shaped structural bracket (38) allows it to be installed easily on one riser (40) from which the hollow section first end (16) is connected as well as the other riser (40′) along with a mechanical fastener (34) so that the tabbed connector (30) can be inserted into it.

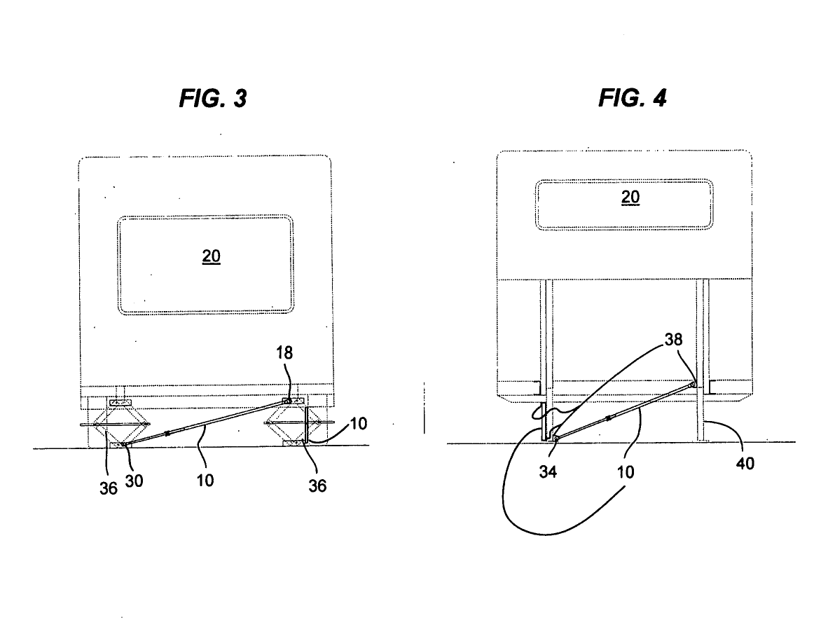

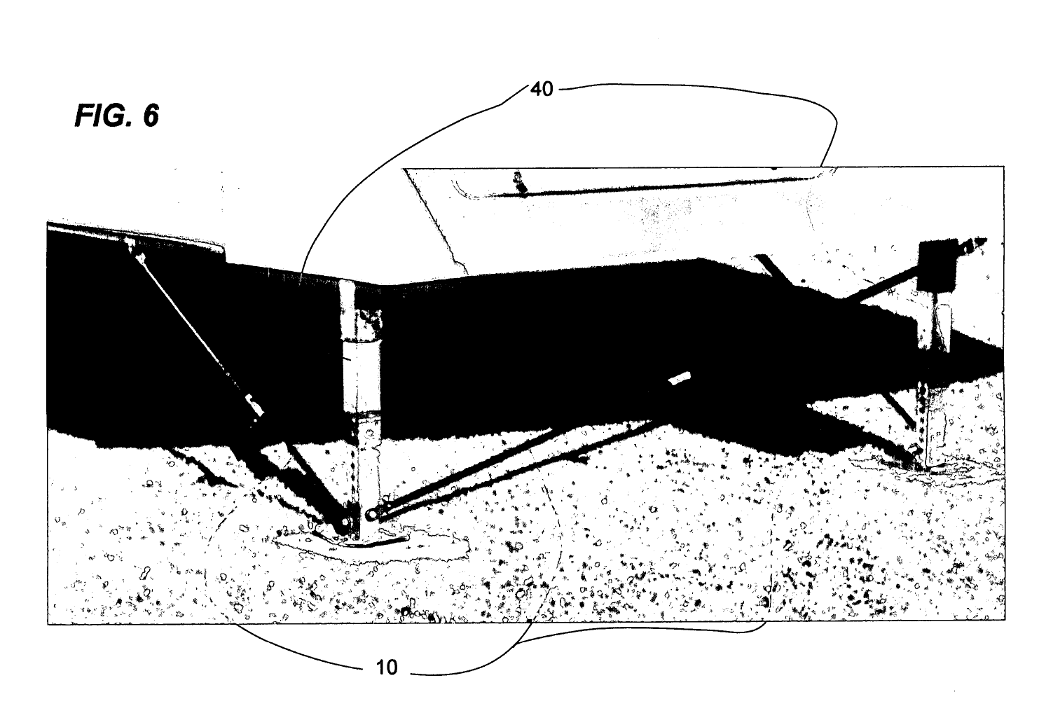

Besides the lateral connections of the telescopic stabilizer (10) as per FIGS. 3-4, a longitudinal connection as per FIG. 1 is also possible in which case one structural bracket (38) is connected to the trailer (20) and the other structural bracket (38) at the base of the jacks (36) or risers (40, 40′). These connections along two axes act as cross beams which provide for an excellent stabilization of the jacks (36), risers (40, 40′) and ultimately, the trailer (20) itself.

Once a camping location has been selected, the jacks (36) or risers (40, 40′) are deployed until a satisfactory degree of leveling has been achieved. By being secured along the length axis, even if the wheels are not properly blocked there is no possible shifting of the trailer (20) because of the telescopic stabilizer (10) set along that axis acts as a stopper.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A telescopic stabilizer for trailers comprising:
two axes of stabilization each comprised of a hollow section to receive a telescoping section;
said hollow section further comprised of a hollow section first end and a hollow section second end;
said hollow section first end having a connector extending therefrom and connecting to a structural bracket and said hollow section second end having an adjustment means to selectively release or block said telescoping section;
said telescoping section having a telescoping section first end and a telescoping section second end;
said telescoping section first end being encased within said hollow section and said telescoping section second end having a tabbed connector extending therefrom;
said structural bracket being connected to any of said trailer, a jack; or a riser, so as to provide said telescopic stabilizer with a cross beam configuration.

2. A telescopic stabilizer as in claim 1 wherein:
said hollow section second end's adjustment means to selectively release or block said telescoping section being a threaded knob.

3. A telescopic stabilizer as in claim 1 wherein:
said tabbed connector having a hole so that a mechanical fastener can pass through it.

4. A telescopic stabilizer as in claim 1 having the following method of use:
a camping location is selected;
said jacks or said risers are deployed until a satisfactory degree of leveling has been achieved.
